(19) United States
(12) Patent Application Publication
(10) Pub. No.: US 2009/0240511 A1
(43) Pub. Date: Sep. 24, 2009

(54) APPARATUS FOR SECURELY STORING DELIVERED GOODS, AN INTEGRATED CONTROLLER FOR USE WITH THE APPARATUS AND A METHOD OF SECURELY SUPPLYING GOODS TO A CUSTOMER

(75) Inventor: Daniel J. Darrouzet, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/051,778

(22) Filed: Mar. 19, 2008

(51) Int. Cl. G06Q 30/00; E05B 65/44; A47B 96/00; G08C 19/00

(52) U.S. Cl. 705/1; 312/236; 70/78; 340/5.7

(57) ABSTRACT

An apparatus, an integrated controller and a method of securely supplying goods to a customer. In one embodiment, the apparatus includes: (1) a chassis having a first compartment configured to store goods at a first temperature and a second compartment configured to store goods at a second temperature different from the first temperature, (2) an access barrier mounted to the chassis and movable between an open position in which access to the first and second compartments is allowed and a closed position in which the access is denied and (3) an integrated controller including an access management system configured to control the access to the first and second compartments through the access barrier and a goods management system configured to track goods deposited to and retrieved from the first and second compartments.

### TECHNICAL FIELD OF THE INVENTION

The invention is directed, in general, to securely delivering goods ordered by a customer over a communications network and, more specifically, to an apparatus for receiving the delivered goods.

### BACKGROUND OF THE INVENTION

Instead of shopping at traditional, so-called “brick-and-mortar” stores, many consumers are using the Internet and/or the telephone to order products for delivery. Consumers may remotely order various types of products including perishable items such as groceries, prepared meals and plants, and non-perishable items such as paper products, clothes, toys and books. In some instances, consumers may order products directly from wholesale suppliers to eliminate a retailer's mark-up. After ordering, the ordered products are delivered to the consumers at specified locations, such as their house or place of business.

The ordered products are typically delivered from the businesses to the specified locations by a logistics or delivery company (i.e., delivery agent). To ensure ordered products are safely received, a customer will often wait at the place of delivery to receive the products from the delivery agent. Otherwise, the delivery agent may leave the products at a front entrance of a house or office. However, leaving an ordered product at an entrance may result in the delivered product being damaged (e.g., due to animals, vandals or weather) or stolen. Additionally, this may reduce the amount of perishable products that are remotely ordered for delivery since the delivered product may spoil before the consumer retrieves it. What is needed is a better system for delivering ordered products to consumers.

### SUMMARY OF THE INVENTION

To address the above-discussed deficiencies of the prior art, one aspect of the disclosure provides an apparatus for securely storing goods delivered to a location. In one embodiment, the apparatus includes: (1) a chassis having a first compartment configured to store goods at a first temperature and a second compartment configured to store goods at a second temperature different from the first temperature, (2) an access barrier mounted to the chassis and movable between an open position in which access to the first and second compartments is allowed and a closed position in which the access is denied and (3) an integrated controller including an access management system configured to control the access to the first and second compartments through the access barrier and a goods management system configured to track goods deposited to and retrieved from the first and second compartments.

In another aspect, the disclosure provides an integrated controller. In one embodiment, the integrated controller includes: (1) an access management system configured to control access to a plurality of pass-through compartments of an apparatus, each of the plurality having an exterior and an interior opening for access thereto and (2) a goods management system configured to monitor goods delivered to the apparatus by tracking when the goods are deposited to the plurality through the exterior openings and when the goods are removed from the plurality through the interior openings.

In yet another aspect, the disclosure provides a method of securely supplying goods to a customer. In one embodiment, the method includes: (1) receiving an order for goods from a customer via a communications network, the order including an indication that the goods are to be delivered to a specified location and a delivery access code that permits authorized access through at least one exterior opening of an apparatus affixed to a structure at the location to allow depositing the goods in the apparatus and (2) providing the goods for delivery to the apparatus, the apparatus including at least one interior opening to allow the customer to access the goods delivered thereto from inside the structure.

### BRIEF DESCRIPTION OF THE DRAWINGS

For a more complete understanding of the invention, reference is now made to the following descriptions taken in conjunction with the accompanying drawings, in which:

FIG. 1 illustrates a block diagram of an embodiment of a secure delivery unit for receiving and storing goods constructed according to the principles of the disclosure;

FIGS. 2A, 2B illustrate examples of a secure delivery unit affixed to a structure;

FIG. 3 illustrates a block diagram of an embodiment of an integrated controller constructed according to the principles of the disclosure; and

FIG. 4 illustrates a flow diagram of an embodiment of a method of supplying ordered goods to a customer carried out according to the principles of the disclosure.

### DETAILED DESCRIPTION OF ILLUSTRATED EMBODIMENTS

The disclosure recognizes that customers may not be present at all times to receive goods that have been ordered for delivery. As such, the disclosure provides an apparatus (e.g., a secure delivery unit) by which ordered goods may be securely stored until retrieved by the customer. The apparatus may include pass-through compartments that allow the ordered goods to be delivered through an opening that is outside of the customer's house and retrieved by the customer through an opening inside of the customer's house.

The apparatus may have multiple compartments that may be maintained at designated temperatures. Accordingly, the apparatus may provide proper storage for various delivered products including frozen foods, groceries and hot pizza. Thus, a customer may order products via, for example, the Internet at any time and any location and request delivery at or by a specified time without having to wait around for the delivery.

An integrated controller may be used with the apparatus to track the goods that are delivered to the apparatus and the goods that are removed from the apparatus by the customer. By tracking the goods, the integrated controller may automatically re-order those goods that need to be replenished. The integrated controller may also control access to the apparatus to prevent unauthorized access. Radio frequency identification (RFID) technology may be used to track the goods and to control access to the apparatus. A high-frequency (e.g., 13.56 MHz), multi-standard RFID reader may be used. For example, a TRF7960 reader commercially available from Texas Instruments Incorporated of Dallas, Tex., may be employed with corresponding tags. Other RFID technology platforms, such as low frequency (e.g., 134.2 kHz) and ultra-high frequency (e.g., 860-960 MHz) may also be employed with the appropriate tags and readers.

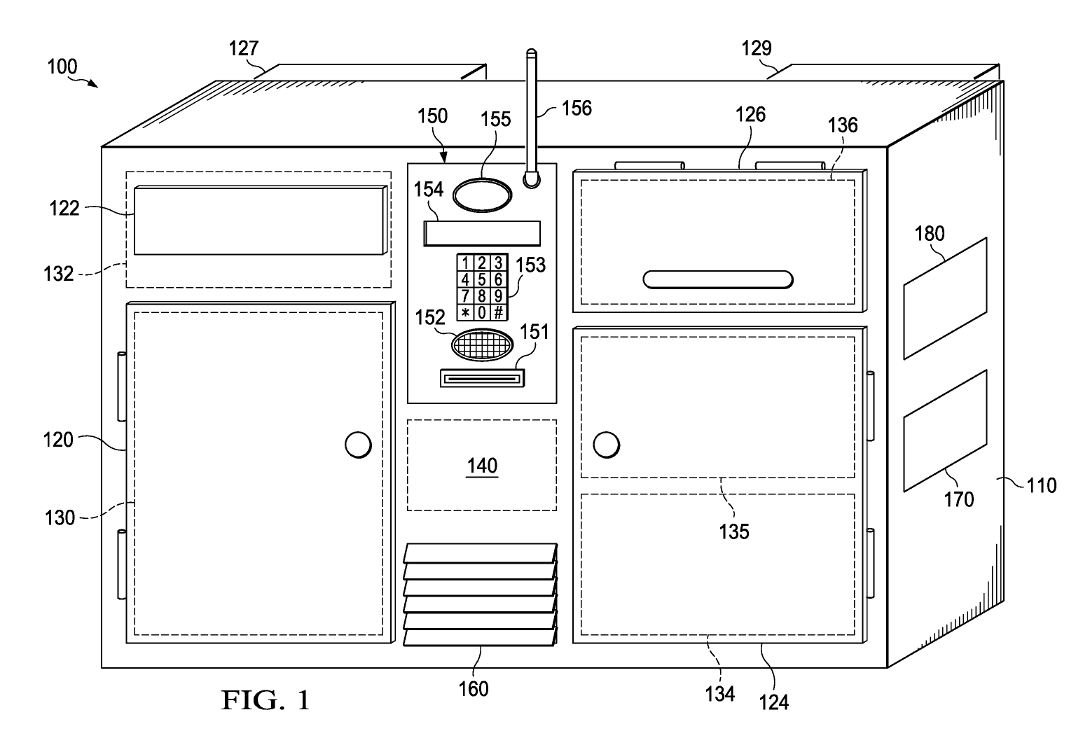

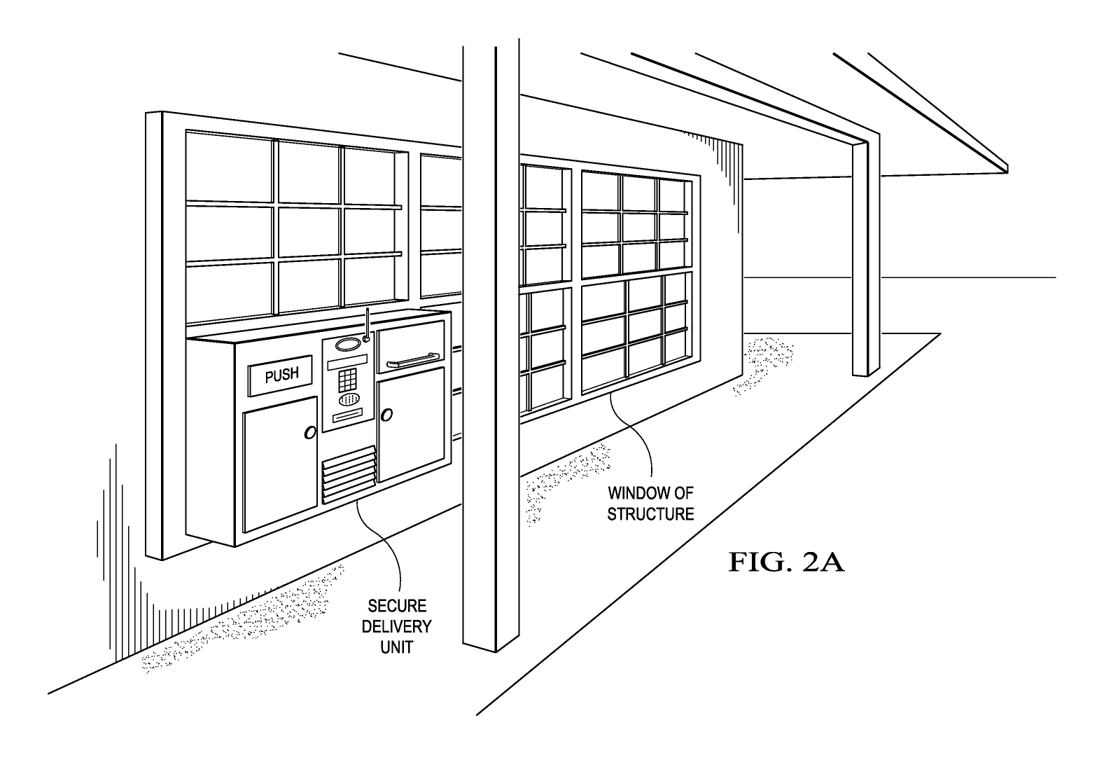

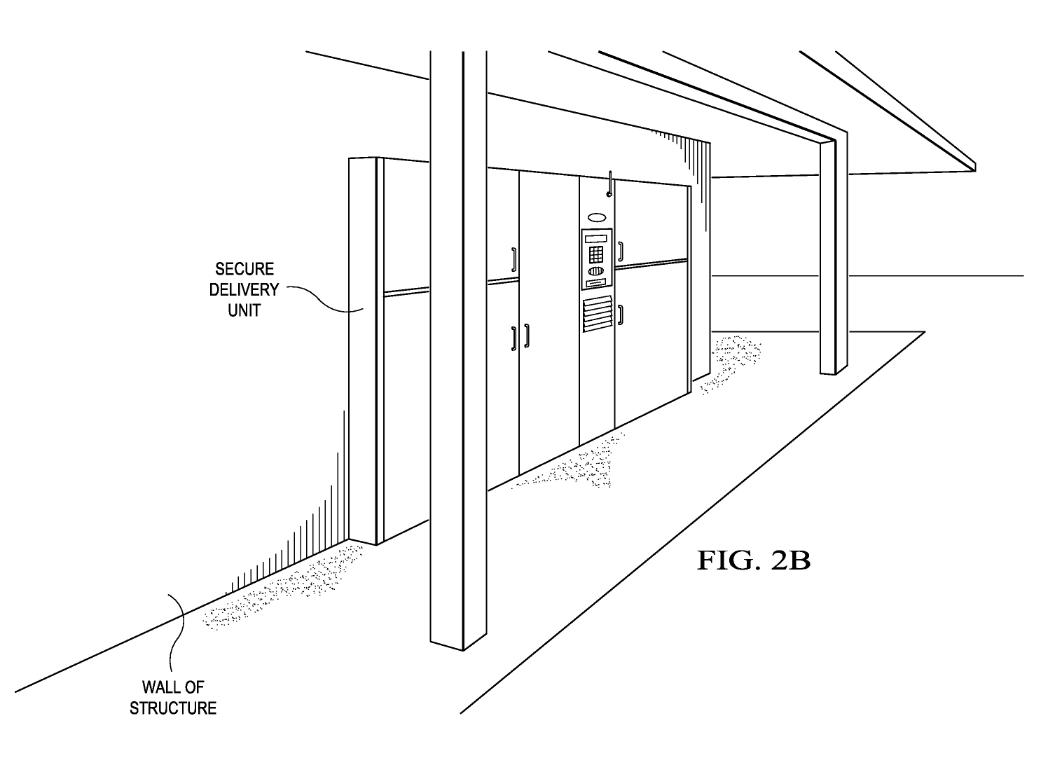

FIG. 1 illustrates a block diagram of an embodiment of a secure delivery unit 100 for receiving and storing goods constructed according to the principles of the disclosure. The unit 100 provides a place where ordered goods may be safely delivered and securely stored until retrieved by a customer. The unit 100 may be located at a business, a house or other locations a customer may designate for the delivery and receipt of goods. The unit 100 may be constructed of a weather-resistant material, such as concrete or stainless steel, to allow at least a portion of the unit 100 to be positioned external to a structure as FIGS. 2A, 2B illustrate. The size of the unit 100 and the type of installation may vary.

The illustrated embodiment of the unit 100 includes a chassis 110, multiple access barriers 120, 122, 124, 126, 127, 129, an integrated controller 140 and an integrated controller interface 150. The chassis 110 provides structural support for the unit 100 and deterrence against unauthorized entry. The chassis 110 includes multiple compartments for receiving, storing and protecting goods. In the embodiment of FIG. 1, each compartment is a pass-through compartment having, for example, four sides with an opening at each end that is protected by an access barrier. Each of the compartments is separated from the other compartments and is enclosed when both access barriers are closed.

The compartments may be maintained at various temperatures and may come in multiple sizes. A large-item compartment (LIC) 130 and a small-item compartment (SIC) 132 may, for example, be for goods that may be safely kept at an ambient temperature. The LIC 130 may be constructed for large packages or those packages that are odd-shaped. The SIC 136 may be for smaller packages or large envelopes.

The other remaining compartments illustrated in FIG. 1 are for goods that need to be maintained at designated temperatures. A frozen-item compartment (FIC) 134 is ostensibly for goods that need to be kept frozen. A cool-item compartment (CIC) 135 is ostensibly for goods that need to be kept cool until retrieved. A warm-item compartment (WIC) 136 is ostensibly for goods that should be kept warmed until retrieved. The FIC 134, CIC 135 and WIC 136 may be insulated to assist in maintaining the proper temperature. A freezer unit and refrigeration unit are included within the secure delivery unit 100 to maintain the proper temperatures for the FIC 134 and the CIC 135. A heating unit, such as a warming drawer, may also be included in the secure delivery unit 100 to provide the proper temperature for the WIC 136. Typically, the freezer unit, refrigeration unit and heating unit are conventional electrical devices.

The access barriers 120, 122, 124, 126, 127, 129 are mounted to the chassis 110 and movable between an open position in which access to a corresponding compartment is allowed and a closed position in which the access is denied. Access barriers 127, 129 represent barriers located on an interior side of the unit 100 and provide access to compartments through the internal openings. The other illustrated access barriers 120, 122, 124, 126 provide external access to the compartments.

An access barrier may only allow access to a single compartment. For example, access barriers 120, 122, 126 allow access to the LIC 130, the SIC 132 and the WIC 136, respectively. Additionally, a single access barrier may allow access to multiple compartments. The access barrier 124 is an example of such an access barrier as it provides access to both the FIC 134 and the CIC 135. The access barriers 124, 126 may be insulated to help maintain the designated temperatures of the FIC 134, the CIC 135 and the WIC 136, respectively.

The design of the access barriers may vary as illustrated in FIG. 1. In some embodiments, the access barriers may be doors that are externally mounted to the chassis 110 via hinges that allow the doors to be open and closed. Examples of these access barriers include access barriers 120, 124, 126. In other embodiments, such as access barrier 122, access barriers may be mounted internal (i.e., hinges are mounted inside) to the chassis 110 and pushed open into the compartments. In some embodiments, an internally-hinged access barrier may be pulled opened away from the compartments. The hinges of the doors may be mounted vertically or horizontally with respect to the base of the chassis 110. Electronic locks (not illustrated) may be used to control the opening and closing of each access barrier. The electronic locks may prevent the interior side doors from being opened from inside the compartments. Bars or another physical barrier may also be used to prevent unauthorized entry into the structure through the compartments.

The illustrated embodiment of the integrated controller 140 takes the form of a computing device having the necessary hardware and software to perform the designated functions described herein. The integrated controller 140 is illustrated as being located inside the chassis 110 and protected from the elements. The integrated controller 140 may be located proximate the CIC 135 and also maintained at a cool temperature. The integrated controller 140 receives information via multiple interfaces to manage the operation of the unit 100, among other things. The integrated controller interface 150 is illustrated to represent the multiple devices that may be used to communicate with the integrated controller 140. The integrated controller interface 150 includes a card reader 151, radio frequency identification (RFID) reader 152, a keypad 153, a display 154, a camera 155 and an antenna 156.

Each of these devices may be a conventional device. The location of the devices of the integrated controller interface 150 on or within the secure delivery unit 100 may be different than those illustrated in FIG. 1. In some embodiments, the integrated controller interface 150 may not include each of the illustrated devices. Of course, in other embodiments, the secure delivery unit 100 may include additional devices to communicate with the integrated controller 140. For example, the secure delivery unit 100 may include a keyboard, display, mouse, or other type of interfaces that a customer may use to communicate with the integrated controller 140. Each of these interfaces may only be accessible from the interior side of the secure delivery unit 100.

The display 154 may be used to provide information to a delivery agent or to the customer. The card reader 151, RFID reader 152, keypad 153, camera 155 and antenna 156 may be used to identify delivery agents or identify goods. Some of the devices, such as the camera, may be used to indicate an unsafe condition for the secure delivery unit 100. The antenna 156 may also be used to communicate with delivery agents.

The integrated controller 140 includes an access management system configured to control access to the multiple compartments through the corresponding access barriers. The integrated controller 140 may operate the electronic locks to control access to the compartments. The RFID reader 152 may be used by the integrated controller 140 to determine who may have access to which compartments and at what time(s).

The integrated controller also includes a goods management system configured to track goods deposited to and retrieved from the compartments. The goods management system may employ at least one RFID reader to recognize the goods deposited to and retrieved from the compartments. The RFID reader 152 may be used to determine which goods are delivered to the unit 100. An additional RFID reader may be located on the interior side of the unit 100 to record when goods are retrieved from the unit 100. In some embodiments, each compartment may include a sensor proximate the external opening and another sensor proximate the internal opening to track when goods are delivered and retrieved. The sensors may be an optical reader such as a bar code reader or may be an RFID reader. The goods management system may automatically reorder some of the goods based on the goods deposited to and retrieved from the compartments as tracked by the sensors.

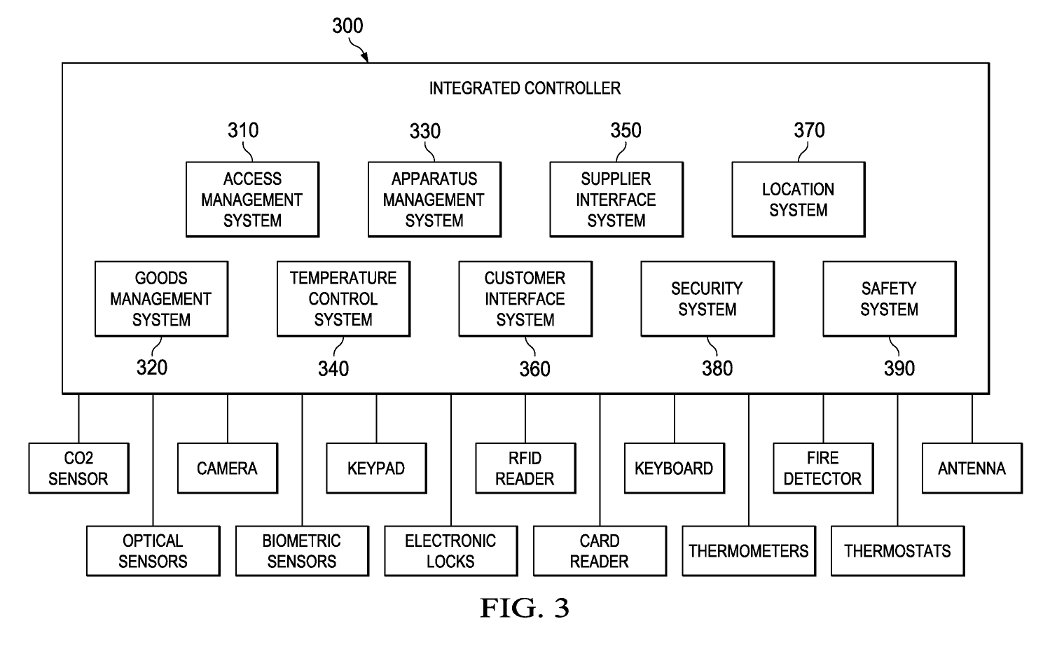

In addition to the access management system and the goods management system, the integrated controller 140 may contain additional management modules to manage the operation of the secure delivery unit 100. For example, the integrated controller 140 may include a temperature control system. The temperature control system may monitor and control the temperature of the FIC 134, the CIC 135 and the WIC 136 by receiving inputs from a sensor (e.g., thermometer) in each compartment and controlling a thermostat associated with the associated freezer unit, refrigeration unit or heater unit. The access management system, goods management system and temperature control system are not illustrated in FIG. 1. These systems and other systems will be discussed in more detail with respect to the integrated controller 300 illustrated in FIG. 3.

The secure delivery unit 100 may also include components or devices that support the operation thereof. Each of these may be conventional components or devices. An illustrated component includes a vent 160 for circulation. Additionally, the secure delivery unit 100 includes an electrical interface 170 and a communications interface 180. The electrical interface 170 is configured to connect to the grid of an electricity provider and provide power for the secure delivery unit 100. Typically, this would be provided by the electrical system of a structure in which the secure delivery unit 100 is affixed. The electrical interface 170 may include the necessary protection and, if needed, conversion equipment for the secure delivery unit 100. In some embodiments, the electrical interface 170 may include a battery back-up.

The communications interface 180 is configured to connect to a communications network and provide access thereto for the secure delivery unit 100. For example, the communications interface 180 may be coupled to the communications network of the structure in which the secure delivery unit 100 is affixed. Through the communications interface 180, the secure delivery unit 100 may communicate via the Internet.

FIGS. 2A, 2B illustrate examples of secure delivery units affixed to a structure, such as a house. In FIG. 2A, the unit 200 is installed in an outer wall of the house. In this installation, the unit 200 may be built-in the wall during original construction of the house. Of course, the unit 200 may also be added at a later time. The unit 200 may be the same unit or similar to the unit 100 in FIG. 1.

In FIG. 2B, the unit 250 is installed in a window of the house allowing an easier add-on to an already built house. Typically, the window unit 250 is smaller than the unit 200 and does not have as many features. The unit 200 may be bolted to the window frame to secure the unit 200 to the house. In each installation, goods may be delivered through the exterior side of the units 200, 250, and retrieved from the interior side by the customer.

FIG. 3 illustrates a block diagram of an embodiment of an integrated controller 300 constructed according to the principles of the disclosure. The integrated controller 300 may be a dedicated apparatus constructed of special-purpose hardware employing a series of operating instructions which direct its operation. In alternative embodiments, the integrated controller 300 may be implemented on a general purpose computing device directed by a sequence of operating instructions. All or at least a portion of the integrated controller 300 may be housed in a secure delivery unit such as the unit 100 in FIG. 1. In alternative embodiments, all or a portion of the integrated controller 300 may be physically located external to a secure delivery unit and coupled thereto through a wireline or wireless connection.

The integrated controller 300 is configured to manage the operation of a secure delivery unit and goods that are ordered and delivered thereto. The integrated controller 300 includes multiple modules that, for example, control access to the secure delivery unit, provide an interface with customers and suppliers and track goods. The type and number of controls and interfaces managed and provided by the integrated controller 300 may vary depending on the model and customer. The integrated controller 300 receives data, such as from sensors of the secure delivery unit, input from customers or suppliers, information from delivery agents, etc., and directs operations based thereon. Examples of some of the devices from which the integrated controller 300 may receive data are illustrated in FIG. 3 to represent inputs to the integrated controller 300. The integrated controller 300 includes an access management system 310, a goods management system 320, an apparatus management system 330, a temperature control system 340, a supplier interface system 350, a customer interface system 360, a location system 370, a security system 380 and a safety system 390.

The access management system 310 is configured to control access to a plurality of pass-through compartments of the secure delivery unit. Each of the plurality of pass-through compartments have access barriers that allow access thereto through an exterior and an interior opening. The access management system 310 employs electronic locks to control opening and closing of the access barriers. The access management system 310 receives data from interfaces associated with the secure delivery unit and determines, based on the data, if the access barriers should be opened to allow access to the compartments. The interfaces may be, for example, a keypad, a card reader or a biometric identifier based on a retinal scan, fingerprints, voice, etc. The access management system 310 may use a table to compare the received data to stored information to determine if access should be granted. In one embodiment, the access management system 310 may include an RFID reader to determine if access should be allowed to a pass-through compartment. A delivery agent, for example, may transmit an RFID signal that is identified by the RFID reader and analyzed by the access management system 310 to determine if access to the delivery agent is granted. If granted, the access management system 310 releases the electronic lock of an access barrier or barriers to allow access. The customer may direct the access management system 310 to allow access to just a single compartment or multiple compartments based on the RFID signal.

The goods management system 320 is configured to monitor goods delivered to the secure delivery unit by tracking when the goods are deposited to the compartment through the exterior openings and when the goods are removed from the compartments through the interior openings. The goods management system 320 may automatically re-order the goods based on the tracking. The goods management system 320 may include an RFID reader to recognize each of the goods deposited to the compartment and another RFID reader to recognize each of the goods removed from the compartments.

The apparatus management system 330 is configured to monitor operating conditions of the secure delivery unit. The apparatus management system 330 may monitor each sensor of the secure delivery unit to determine if a device is faulty. The apparatus management system 330 may insure the electrical connection and communications connection of the secure delivery unit are operating properly. The apparatus management system 330 may also monitor the various systems of the integrated controller 300 to determine if each system is functioning properly.

The temperature control system 340 is configured to maintain the desired temperatures for the various compartments. The temperature control system 340 may direct the appropriate freezer unit, refrigeration unit or warming unit to maintain a freezing temperature for a FIC compartment, a chilled temperature for a CIC compartment or a warm temperature for a WIC compartment. The temperatures may be constantly maintained or only maintained when goods are placed in the particular compartment. Additionally, the temperature may be established in each compartment based on the delivery time indicated in the order for the goods. As such, the temperature control system 340 may interact with the goods management system 320 to determine when goods are placed in the compartment or when the goods will be delivered.

The supplier interface system 350 is configured to provide communication between a supplier of the goods and a customer associated with the secure delivery unit. An antenna may be used to communicate with the supplier. Additionally, communications with the supplier may be established through an Internet connection. The supplier interface system 350 may be used to indicate sale items to the customer, suggest substitute products, provide billing information, etc. The customer may also use the supplier interface system 350 to request information about products, change deliveries, pay invoices, etc.

The customer interface system 360 is configured to allow a customer associated with the secure delivery unit to manage operation thereof and inventory of the goods. The customer interface system 360 allows a customer to interact with the integrated controller 300 and establish or change various parameters for the included systems. The customer interface system 360 may include the keyboard, mouse, display, microphone, keypad, speaker and other devices that allow the customer to input information and receive feedback from the integrated controller 300. Through the customer interface system 360, the customer may establish access parameters for the interior or exterior sides of the secure delivery unit. Additionally, the customer interface system 360 may allow a customer to program desired temperatures for the temperature control system 340, determine inventory limits for goods via the goods management system 320, establish a list of products to purchase, etc. The particular temperatures for various compartments may be based on industry standards for freezers, refrigerators or warming units such as a warming drawer.

The location system 370 is configured to transmit a location of the apparatus to a delivery agent of the goods. The location system 370 may use GPS technology to assist a delivery agent in locating the secure delivery unit. An antenna may be used to communicate with a particular delivery agent vehicle of with a delivery agent company.

The security system 380 is configured to generate an alarm when detecting a security problem associated with the secure delivery unit. The security system 380 may determine a security problem based on input from the sensors or interfaces associated with the secure delivery unit. A forced entry may be indicated by the electronic locks of a secure delivery unit. Additionally, a camera may indicate damage to the secure delivery unit or proximate dangerous conditions such as, rising water, vandals, etc. The security problem may be a potential security issue.

The safety system 390 is configured to generate an alarm when detecting an unsafe condition associated with the secure delivery unit. The safety system 390 may rely on inputs from sensors located within or about the secure delivery unit. The safety system 390 may generate an alarm based on a CO2 sensor located proximate an LIC of the secure delivery unit. The generated alarm can notify the user that a person, such as a child, or an animal is within the LIC. Another sensor, such as a smoke detector, may be used by the safety system 390 to monitor for fire in or about the secure delivery unit. In some embodiments, the smoke detector may be located proximate the WIC.

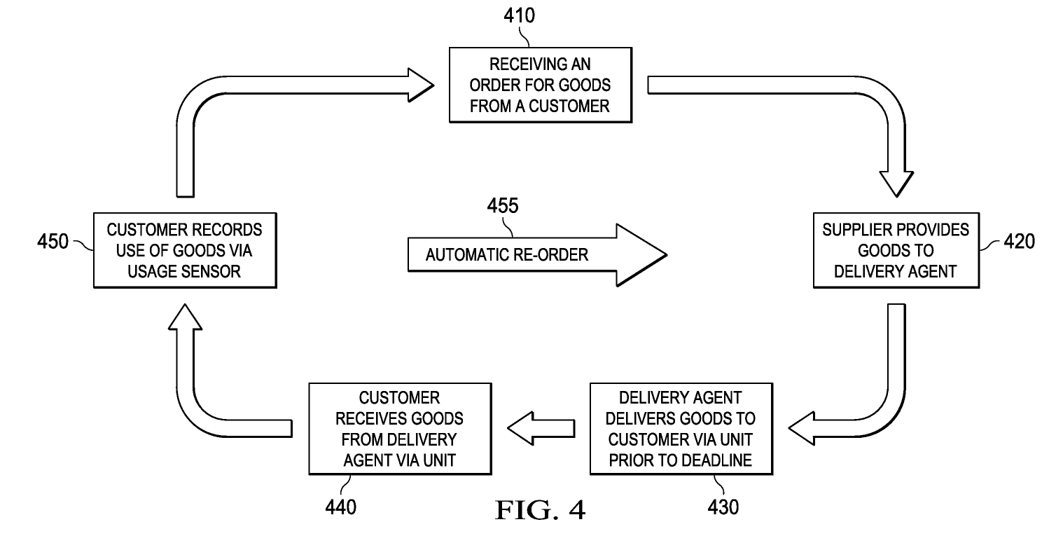

FIG. 4 illustrates a flow diagram of an embodiment of a method 400 of supplying ordered goods to a customer carried out according to the principles of the disclosure. The method 400 begins in a step 410 with a supplier receiving an order for goods from a customer. A supplier is an entity that offers goods for sale. A supplier may be, for example, a wholesale or retail distributor of goods. The order for the goods includes an indication that the goods are to be delivered to a specified location and a delivery access code that permits authorized access through at least one exterior opening of an apparatus affixed to a structure at the location to allow depositing the goods in the apparatus. The apparatus may be a secure delivery unit having at least one interior opening to allow the customer to access the goods delivered thereto from inside the structure. The delivery access code may be an alphanumeric code that may be entered in a keypad or may be an RFID signal that an RFID reader may read. The order may be received remotely from the customer via a communications network. For example, the order may be received via the Internet or via the telephone. In some embodiments, an order may be received by postal mail.

After receiving the order, the goods are provided for delivery to the apparatus in a step 420. The supplier may deliver the goods to the secure delivery unit. In other embodiments, the supplier may contact an independent delivery agent to deliver the goods to the secure delivery unit. Examples of such independent delivery agents include FedEx, UPS and DHL.

After receiving the goods provided thereto, the delivery agent delivers the goods to the customer via the secure delivery unit prior to the deadline in a step 430. The delivery agent may obtain access to exterior openings of the compartments of the secure delivery unit via an access management system. An RFID reader, for example, may be used to identify the delivery agent and the particular goods ordered. Based on the identification of the delivery agent and goods, the access management system may determine if access should be allowed or not to one or all of the compartments of the secure delivery unit.

After delivering the goods to the secure delivery unit, the customer may retrieve the goods from the secure delivery unit in a step 440. The customer may retrieve the goods from an interior opening of the compartment holding the goods. As such, the goods may be delivered external to a structure and securely stored until the customer retrieves the goods from inside the structure.

After retrieving the goods, the customer records usage of the goods in a step 450. The customer may record usage of the goods when removed from the secure delivery unit. A sensor may automatically record the removal of the goods. An RFID reader may be used to determine when the goods have been removed. In other embodiments, another type of sensor, such as a bar code reader, may be used to determine the usage of goods. The sensor or sensors may be located at or distal from the secure delivery unit. The customer may also manually enter when the goods have been used via an interface (e.g., keyboard, keypad, touch screen, microphone, text message via cell phone, etc.) with a goods management system of the secure delivery unit. The method 400 then continues to step 410 where another order is received for goods. In some embodiments, an order for goods may be automatically generated in a step 455. The goods management system of the secure delivery unit may determine more goods are needed based on use and automatically order the goods. The customer may control what goods are to be automatically re-ordered and those that must be manually ordered. The customer may use a customer interface system to provide inputs to the goods management system.

The above-described integrated controller and the plurality of systems included therein may be embodied in or performed by various conventional digital data processors or computers, wherein the computers are programmed or store executable programs of sequences of software instructions to perform one or more of the functions of the systems, e.g., the systems represented in FIG. 3. The software instructions of such programs may be encoded in machine-executable form on conventional digital data storage media, e.g., magnetic or optical disks, random-access memory (RAM), magnetic hard disks, flash memories, and/or read-only memory (ROM), to enable various types of digital data processors or computers to perform one, multiple or all of the functions of one or more of the above-described systems, e.g., one or more of the systems represented in FIG. 3.

Those skilled in the art to which the invention relates will appreciate that other and further additions, deletions, substitutions and modifications may be made to the described embodiments without departing from the scope of the invention.

What is claimed is:

1. An apparatus for securely storing goods delivered to a location, comprising:
a chassis having a first compartment configured to store goods at a first temperature and a second compartment configured to store goods at a second temperature different from said first temperature;
an access barrier mounted to said chassis and movable between an open position in which access to said first and second compartments is allowed and a closed position in which said access is denied; and
an integrated controller including an access management system configured to control said access to said first and second compartments through said access barrier and a goods management system configured to track goods deposited to and retrieved from said first and second compartments.

2. The apparatus as recited in claim 1 wherein each of said first and second compartments are pass-through compartments having an exterior and an interior opening, said access barrier mounted to said chassis to allow said access through said exterior openings.

3. The apparatus as recited in claim 2 further comprising another access barrier mounted to said chassis to allow access to said first and second compartments through said interior openings.

4. The apparatus as recited in claim 3 wherein at least one of said access barrier and said another access barrier includes a separate door for each of said exterior or interior openings.

5. The apparatus as recited in claim 3 further comprising a security barrier to prevent unauthorized opening of said another access barrier from inside of said first or second compartments.

6. The apparatus as recited in claim 1 further comprising a third compartment configured to store goods at a third temperature different from said first and second temperatures.

7. The apparatus as recited in claim 1 wherein said access management system employs a radio frequency identification (RFID) reader to control said access.

8. The apparatus as recited in claim 1 wherein said goods management system employs at least one RFID reader to recognize said goods deposited to and retrieved from said first and second compartments.

9. The apparatus as recited in claim 8 wherein said goods management system automatically reorders at least some of said goods based on said goods deposited to and retrieved from said first and second compartments.

10. An integrated controller, comprising:
an access management system configured to control access to a plurality of pass-through compartments of an apparatus, each of said plurality having an exterior and an interior opening for access thereto; and
a goods management system configured to monitor goods delivered to said apparatus by tracking when said goods are deposited to said plurality through said exterior openings and when said goods are removed from said plurality through said interior openings.

11. The integrated controller as recited in claim 10 wherein said goods management system is further configured to automatically re-order said goods based on said tracking.

12. The integrated controller as recited in claim 10 wherein said goods management system employs at least one RFID reader to recognize each of said goods deposited to said plurality and at least another RFID reader to recognize each of said goods removed from said plurality.

13. The integrated controller as recited in claim 10 wherein said access management system employs an RFID reader to control access to said plurality of pass-through compartments.

14. The integrated controller as recited in claim 10 further comprising an apparatus management system configured to monitor operating conditions of said apparatus.

15. The integrated controller as recited in claim 10 further comprising a temperature control system configured to maintain a first temperature in a first one of said plurality and a second temperature different from said first temperature in a second one of said plurality.

16. The integrated controller as recited in claim 10 further comprising a supplier interface system configured to provide communication between a supplier of said goods and a customer associated with said apparatus.

17. The integrated controller as recited in claim 10 further comprising a customer interface system configured to allow a customer associated with said apparatus to manage operation of said apparatus and inventory of said goods.

18. The integrated controller as recited in claim 10 further comprising a location system configured to transmit a location of said apparatus to a delivery agent of said goods.

19. The integrated controller as recited in claim 10 further comprising a security system configured to generate an alarm when detecting a security problem associated with said apparatus.

20. The integrated controller as recited in claim 10 further comprising a safety system configured to generate an alarm when detecting an unsafe condition associated with said apparatus.

21. A method of securely supplying goods to a customer, comprising:
receiving an order for goods from a customer via a communications network, said order including an indication that said goods are to be delivered to a specified location and a delivery access code that permits authorized access through at least one exterior opening of an apparatus affixed to a structure at said location to allow depositing said goods in said apparatus; and
providing said goods for delivery to said apparatus, said apparatus including at least one interior opening to allow said customer to access said goods delivered thereto from inside said structure.
